(19) United States
(12) Patent Application Publication
(10) Pub. No.: US 2005/0112393 A1
(43) Pub. Date: May 26, 2005

(54) Antifungal preservative composition for an environmentally friendly process

(76) Inventor: Carl B. Fliermans, Augusta, GA (US)

Correspondence Address: J. BENNETT MULLINAX, LLC, P. O. BOX 26029, GREENVILLE, SC, 29616-1029, US

(21) Appl. No.: 10/718,389

(22) Filed: Nov. 20, 2003

(51) Int. Cl. B05D 1/02; B32B 21/04; B05D 7/06; C09D 5/14; B32B 9/02

(52) U.S. Cl. 428/537.1; 428/541; 106/15.05; 427/397; 427/427.7

(57) ABSTRACT

A wood treatment solution and method is described in which stabilized extracts of garlic (Allium sativum) are used to reduce or prevent the growth of common fungi on wood products. The garlic extracts used to treat the wood are safe for workers, consumers, and the environment. The garlic extracts are also believed useful in controlling mold and mildew on other organic substrates as well as nonporous household surfaces.

### FIELD OF THE INVENTION

This invention is directed towards a method and composition for protecting organic substances and particularly wood to prevent mold and associated staining and decay using an extract of Allium sativum.

### BACKGROUND OF THE INVENTION

Wood provides an organic substrate which is an ideal growth medium for fungi. Commercially harvested wood is particularly subject to growth and attack by sapstain fungi and mold. During warm, humid conditions, green lumber is typically infested by fungi within a matter of weeks. Fungal growth produces undesirable black or greenish-blue stains which largely affect the aesthetics of the lumber. While structurally sound, the stained wood is less attractive for subsequent purchasers.

The growth of other fungi may result in physical damage to the underlying wood/fiber structure. Accordingly, there is a need to provide treatments which prevent the fungal induced staining and decay in green lumber. In addition to green lumber, pressure treated lumber and other wood products are often stored for long periods under a variety of environmental conditions. The conditions may include exposure to rain and moisture, storage in high humidity conditions, or involve shipment and transport where the lumber may be exposed to conditions which facilitate the growth of mold. To combat mold growth, a variety of commercial products have been designed to prevent mold stains and degradation in lumber. For instance, various chlorophenols and/or borax mixtures are effective in reducing mold but are subject to increasing concerns regarding their toxicity and environmental impact. Thus, there is a need within the art to provide cost-effective, safe treatments to prevent mold growth in green wood and processed lumber products. Accordingly, the present invention is directed to a coating composition and a method of protecting wood against mold and fungi using a product that is environmentally friendly.

Allium sativum (garlic) garlic extracts and components have been extensively used and studied with respect to their medicinal properties. Medicinal research indicates that garlic contains 33 sulfur compounds, 17 amino acids, along with numerous enzymes and trace metals. The sulfur-containing compounds include aliin, allicin, ajoene, allypropyl, diallyl trisulfide, S-allycysteine, S-allylmercaptocystein, S-allyl cysteine sulfoxide, vinyldithiines, diallyl trisulfide, diallyl disulfide, 2-vinyl-1,3-dithiene, allyl 1,5-hexadienyltrisulfide, methyl propyl disulfide, propylene sulfide, allyl methyl sulfide, and dipropyl disulfide.

Reported enzymes include allinase, peroxidases, myrosinase, and glutathione-S-transferase. Additionally, various antioxidant agents have been reported including trace elements of selenium and tellurium.

Garlic has been reported to have antimicrobial properties which have been attributed to the compounds alliin and ajoene. During the extraction forming step, alliin is released upon processing and is reacted upon by allinase to form allicin and ajoene. These sulfur containing compounds are responsible for the microbialstatic and microbialcidal properties. To maintain these properties the preparation must be made without heat since allicinase is destroyed by heat and acidic conditions. The anti-microbial action is due to the fact that allicin and ajoene bind to the cysteine amino acids of proteins and enzymes causing their deactivation. The deactivation prevents the growth of microbial entities including viruses, protozoa, fungi and bacteria. In general, aerobic bacteria are more susceptible than anaerobic bacteria, but both Gram-negative and Gram-positive are affected.

Garlic has been shown to have inhibitory properties against a variety of human pathogens including bacteria and viruses, as well as parasites such as Entomoeba histolytica, Ascaris lumbricoides and Giardia lamblia.

Garlic extracts have also been evaluated in the medical context for fungistatic and fungicidal properties. In this regard, garlic, garlic extracts and garlic derived compounds have been reported as having some inhibitory effects upon Histoplasma capsulatum, Torulopis, Trichosporum, Candida albicans, Aspergillus spp, Aspergillus niger, Cryptoccus neoformans, Rhodotorula, dermatophytes, Microsporium canis, Microsporium gypseum, Microsporium audouini, Trichophyton rubrum, Trichophyton mentagrophytes, Trichophyton violaceum, Trichophyton simii, Trichophyton verrucosum, Trichophyton erinacei and Epridermophyton floccosum.

Heretofore, the reported uses for garlic and garlic extracts have been confined to medicinal purposes and research. There has been no suggestion that garlic extracts may be useful as a biological control agent for applications outside the medical field.

### SUMMARY OF THE INVENTION

It is one aspect of at least one of the embodiments of the present invention to provide for a composition and a treatment process to prevent the growth of mold on green lumber.

It is yet another aspect of at least one of the embodiments of the present invention to provide for a wood preservative composition comprising an extract of Allium sativum. The extract of Allium sativum may be diluted up to 100 million fold so as to provide fungistatic properties when applied to green wood, dried wood, pressure treated wood, or incorporated into other wood preserving compositions.

It is yet a further aspect of at least one of the embodiments of the present invention to provide for a composition and a treatment process for treating cellulosic materials so as to render the cellulosic materials resistant to fungal growth. The coating composition comprises a soluble extract of Allium sativum. The biological extract or emulsion, when topically applied to cellulosic materials, provides for a substantially fungal-free product for at least a 90-day interval. As such, the Allium sativum emulsion may be used as a topical application on cellulosic products to prevent growth of mold during the processing, shipping, or storage of the cellulosic products.

It is a further aspect of at least one of the embodiments of the present invention to provide a composition and process for preventing growth of mold on wood products, the process and composition being compatible for use in combination with other conventional wood preserving treatments including pressure treatments.

It is a further aspect of at least one of the embodiments of the present invention to provide for a treated article of lumber, such as a board or post, in which at least a surface of the lumber article contains an effective amount of an antifungal agent, the antifungal agent comprising an extract of Allium sativum.

It is yet a further aspect of at least one of the embodiments of the present invention to provide for an effective amount of an extract of Allium sativum which may be incorporated into a cleaning product. The resulting cleaning product, containing an effective amount of the antifungal garlic extract, can provide a residual antifungal property to a resulting cleaned surface. Useful applications may include cleaners for pressure washing applications such as cleaning concrete, brick, siding, wooden decks, and similar structures. Similar cleaners used in non-pressurized applications may be used to clean and prevent mold from roofing tiles, marine fabrics such as upholstery and carpeting, outdoor furniture and fabrics, and other porous and non-porous substrates where mold and mildew growth frequently occur.

It is yet a further aspect of at least one of the embodiments of the present invention to provide a non-toxic mold and mildew inhibitor which can be added to a number of organic substrates such as wood, seeds, harvested grains and nuts, fruit, and other food products, so as to reduce the occurrence, spread, and/or relative amount of mold or mildew which may occur.

It is yet a further aspect of at least one of the embodiments of the present invention to provide for a composition and process to prevent the growth of mold on various substrates such as porcelain, bathroom tile, metals, fiberglass, plastic and other non-porous surfaces upon which household mold and mildew grow. While such non-porous substrates do not themselves provide a substrate which supports fungal growth, such materials frequently acquire a film of organic material such as dirt or detergents. This organic film, combined with the moist environment, provides a substrate for fungal growth. Use of the composition described herein will substantially reduce the growth of such organisms. An additional embodiment deals with the use of fungicide on lawns, turf grass industry and golf course management.

These and other features, aspects, and advantages of the present invention will become better understood with reference to the following description and appended claims.

### DESCRIPTION OF THE PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various embodiments or examples herein, the same references or terms are used throughout to describe the same material, composition or process pathway. To avoid redundancy, detailed descriptions of a material or process are not repeated in the descriptions of subsequent examples, although such material or process is labeled with the same reference term.

The present invention is directed to an extract of Allium sativum (garlic) which may be used as a fungistatic and/or fungicide for organic materials including cellulosic material such as wood. As used herein, the Allium sativum extracts produced and used are referred to as a “Natural Emulsoid Lixivian” (NEL). The fungicidal and fungistatic properties of the NEL product may be used to provide protection to organic materials. By way of example, organic materials such as green wood products, cured lumber, and pressure treated lumber may be treated by (1) spraying a working solution of the NEL onto the surface of green, cured, or pressure treated lumber; (2) dipping green, cured, or pressure treated lumber into a working solution of the extract; or (3) applying the working solution under pressure to a wood product. The resulting lumber has at least a surface portion of a lumber containing an effective amount of NEL so as to reduce or eliminate fungal growth. To the extent the NEL is allowed to soak or is applied by pressure to a wood product, the NEL is believed to penetrate more deeply into the wood and confer an enhanced level of protection against the growth of fungi on the NEL-treated lumber.

The NEL is odorless and environmentally friendly. It does not accumulate in the environment. It is not toxic to plant or animal life at operational concentrations. Garlic is listed on the “Generally Recognized As Safe” (GRAS) list of the United States Food and Drug Administration. Following dilution of the extract, the diluted extract has concentrations of the above mentioned constituents which are thousands of times less concentrated than the amount of the constituents one routinely ingests as part of one's diet. Accordingly, it is believed that the NEL, when used as a wood preservative as described below, presents no health, toxicity, or environmental concerns.

### Preparation of the NEL Product

Garlic bulbs are macerated in a pulp extraction centrifugal grinder at a temperature of about 4° C. The tissue and pulp of the garlic bulbs are removed from the maceration product by centrifugation at 500 rpm. The resulting extract is a multi-phase emulsion in which the various phases are all soluble in water and aqueous solutions. The extract is stabilized with 0.1 M Phosphate Buffered Saline (PBS) at pH 7.2 using a 1:1 extract to PBS. The resulting stabilized NEL is maintained at a temperature of about 4° C. and may thereafter be further diluted to form various working concentrations as identified below. If desired, sorbate (0.01-0.1M) and/or benzoate (0.01-0.1M) may be added to stabilize the NEL against loss of metabolic activity. The initial extract or stabilized extract may also be lyophilized into a stable powder.

### EXAMPLE 1

A stock solution of the stabilized 1:1 extract to PBS was further diluted with 0.1 M PBS to concentrations of 1:100; 1:10,000; 1:1,000,000; 1:100,000,000; and 1:10,000,000,000. The stock solution and the various diluents were used to saturate sterile Millipore™ borosilicate microfiber glass, binder-free pre-filters. The saturated pre-filters were then placed on agar PTYG cultures of a consortium of brown and white rot fungi. These fungi are commonly found growing on wholesale and retail lumber. The cultures with the saturated pre-filters were incubated for 48 hours at 37° C. Each sample was kept in a separate Whirl-Pak™ bag to eliminate any crossover effect from the possible release of volatile compounds, and to insure that the moisture content and humidity of the stakes are maintained. Following the 48 hour incubation time, the distance of any cleared zone surrounding the pre-filters was measured as is conventional for antibiotic sensitivity testing. The results from the triplicate replicates are set forth in Table 1. As evidenced by the data reported in Table 1, concentrations corresponding to the 1:100 to the 1:100,000,000 are inhibitory to the growth of a wood rot fungal consortium under laboratory conditions. The observed level of fungal inhibition corresponds to the concentration of the NEL applied to the pre-filter.

TABLE 1
Minimum Inhibitory Concentration testing of NEL-102, NEL-104,
NEL-106, NEL-108 and NEL-110

| | Cleared zone at 48 hours |
|---|---|
| Replicate A. | |
| Treatment | |
| NEL-102 (1:100) | 26 mm |
| NEL-104 (1:10,000) | 22 mm |
| NEL-106 (1:100,000) | 17 mm |
| NEL-108 (1:1,000,000) | 3 mm |
| NEL-110 (1:10,000,000) | Confluent growth |
| Replicate B. | |
| Treatment | |
| NEL-102 (1:100) | 25 mm |
| NEL-104 (1:10,000) | 23 mm |
| NEL-106 (1:100,000) | 15 mm |
| NEL-108 (1:1,000,000) | 2 mm |
| NEL-110 (1:10,000,000) | Confluent growth |
| Replicate C. | |
| Treatment | |
| NEL-102 (1:100) | 31 mm |
| NEL-104 (1:10,000) | 28 mm |
| NEL-106 (1:100,000) | 15 mm |
| NEL-108 (1:1,000,000) | ±1 mm |
| NEL-110 (1:10,000,000) | Confluent growth |

### EXAMPLE 2

The efficacy of the NEL was evaluated on green lumber. Standard Southern pine green stakes (Falstrom stakes) having dimensions of 10″×1.5″ by 0.25″ were obtained. Duplicate stakes were numbered, weighed, and placed in the NEL concentrations identified in Example 1. In addition, duplicate stakes were treated with the 1:1 NEL stock solution.

Each Falstrom stake was placed in a respective concentration and volume of NEL such that a 60 mm portion of each stake was covered. Each stake remained in the respective concentration for 48 hours at room temperature.

Following exposure to the NEL solution, the entire length of each stake was streaked with a PBS fungal suspension of the brown and white rot fungi consortium identified in Example 1. Each stake was thereafter placed in an individual sterile Whirl-Pak™ bag and incubated in the dark at 37° C. Incubation occurred for 68 days at which time each Falstrom stake was microscopically observed for the presence of fungal growth over the entire length of the Falstrom stake. As set forth in Table 2, the extent of fungal growth in millimeters is compared to control samples and expressed in the percentage of fungal cover compared to the control. The control sample is a positive control having the PBS fungal suspension applied with no NEL present.

As indicated in Table 2, the various concentrations of the NEL offer varying degrees of control of fungal growth. Again, the effectiveness of the NEL correlates with the concentration of the extract. As seen, significant reductions in fungal growth occur with concentrations ranging from the 1:1 stabilized stock solution to the 1:100,000,000 dilution.

TABLE 2
Fungal Inhibition by NEL-101, NEL-102, NEL-104, NEL-106,
NEL-108 and NEL-110 as a Hydrobath Treatment

| | | Distance of Fungal | |
|---|---|---|---|
| | | Growth in mm (% | Duration of |
| Stake # | Treatment | of positive control) | Experiment |
| 70 A | NEL-110 | 234 (93.6%) | 68 days |
| 70 B | NEL-110 | 241 (96.4%) | 68 days |
| 69 A | NEL-108 | 154 (61.6%) | 68 days |
| 69 B | NEL-108 | 154 (61.6%) | 68 days |
| 68 A | NEL-106 | 125 (58.4%) | 68 days |
| 68 B | NEL-106 | 121 (48.4%) | 68 days |
| 67 A | NEL-104 | 81 (32.4%) | 68 days |
| 67 B | NEL-104 | 67 (26.8%) | 68 days |
| 66 A | NEL-102 | 45 (18.0%) | 68 days |
| 66 B | NEL-102 | 26 (10.4%) | 68 days |
| 65 A | NEL-101 | 0 (0%) | 68 days |
| 65 B | NEL-101 | 0 (0%) | 68 days |
| 61 A | None (control) | 254 (100%) | 68 days |
| 61 B | None (control) | 254 (100%) | 68 days |

### EXAMPLE 3

Falstrom stakes as identified in Example 2 were weighed to the nearest 0.001 gram and placed in a pressure treating vessel. A commercially available wood treatment product Osmose NW100™ (Osmose, Inc., Buffalo, N.Y.) was used in combination with the indicated concentrations of the NEL. The Osmose NW100™ product is a copper combined with a quaternary ammonium compound which is dissolved in an alkaline carrier system of ethanolamine and/or ammonia. Positive controls included stakes treated only with Osmose NW100™ (without NEL). The Falstrom stakes were placed under a vacuum of 24 to 28 inches of mercury and maintained for 5 minutes followed by pressure treatment. The pressure treatment consisted of application of the Osmose NW100™ pressure treatment solution at 125 psi for 5 minutes. Following removal of the pressure, a vacuum of 24 inches of mercury was applied to dry the Falstrom stakes. Following equilibration with normal atmospheric conditions, the Falstrom stakes were removed and weighed to determine the amount of Osmose NW100™ introduced into each stake.

The above process was repeated for additional Falstrom stakes in which the Osmose NW100™ formula also contained the indicated concentration of NEL. The Falstrom stakes were then inoculated with the fungal inoculant as described in Examples 1 and 2 above. Each stake was individually placed in a sterile Whirl-Pak™ bag and incubated in the dark at 37° C. for 68 days. Periodically during the incubation phase, the bags and stakes were removed from the incubator and observed microscopically. The results of the data are shown in Table 3.

As seen in Table 3, the Osmose NW100™ treatment in and of itself does not provide significant protection against fungal growth. When the Osmose NW100™ is combined with the indicated concentrations of NEL, a significant reduction in fungal growth was noted.

TABLE 3
Fungal Inhibition by NEL-103, NEL-104, and NEL-106 used in
Combination with Wood Preservation Pressure Treatment After 68 Days
of Incubation

| | | | Number of |
|---|---|---|---|
| | | Inoculated with | Fungal Colonies |
| | | Fungal | After 68 days of |
| Stake # | Treatment | Suspension | Incubation |
| 34 | NW100 (+Control) | YES | TNTC |
| 35 | NW100 (+Control) | YES | TNTC |
| 37 | NW100/NEL-106 | YES | 21 |
| 38 | NW100/NEL-106 | YES | 7 |
| 39 | NW100/NEL-106 | NO | 0 |
| 40 | NW100/NEL-106 | NO | 0 |
| 52 | NW100/NEL-104 | YES | 0 |
| 53 | NW100/NEL-104 | YES | 1 |
| 54 | NW100/NEL-104 | NO | 0 |
| 55 | NW100/NEL-104 | NO | 0 |
| 56 | NW100/NEL-103 | NO | 0 |
| 58 | NW100/NEL-103 | NO | 0 |
| 59 | NW100/NEL-103 | YES | 0 |
| 60 | NW100/NEL-103 | YES | 4 |

TNTC = To Numerous To Count (>300 colony forming units or confluent growth)

### EXAMPLE 4

Additional testing was used with the Osmose NW100™ and Falstrom stakes as set forth in Example 3. Following inoculation, the Falstrom stakes as identified in Table 4 were incubated under black plastic at ambient outdoor environmental temperatures ranging from 72° F. to 93° F. The data obtained and analyzed is set forth in Table 4 below.

TABLE 4
Fungal Inhibition by NEL-103, NEL-104, and NEL-106 used in
Combination with Wood Preservation Pressure Techniques After 68 Days
of Incubation

| | | | Number of |
|---|---|---|---|
| | | Inoculated with | Fungal Colonies |
| | | Fungal | After 68 days of |
| Stake # | Treatment | Suspension | Incubation |
| 33 | NW100 (+Control) | YES | 54 |
| 36 | NW100/NEL-106 | YES | No Growth |
| 51 | NW100/NEL-104 | YES | 6 |
| 57 | NW100/NEL-103 | YES | 2 |

As seen in reference to the data in Table 4, the effectiveness of a conventional wood preservative such as the Osmose NW100™ is enhanced with regard to fungal control abilities by combining with NEL.

As seen from the data set forth above, the NEL identified herein offer an effective method for controlling the establishment and growth of common wood fungi. The treatment process is suitable for green wood, dried lumber products, and pressure treated products. Further, the NEL described herein may be used with effectiveness for fungal growth protection as the sole treatment or combined with an existing wood preservative to offer resistance against a broader range of organisms.

Additionally, it is believed that the NEL described herein may also be useful in combination with a variety of known fungicides so as to bring about a better control of fungal growth. In many instances, it is believed that the combination of the NEL may allow one to reduce the amounts of other fungicides and other wood preservatives, thereby offering cost savings. To the extent there may be perceived health or environmental concerns with existing wood preservatives and fungicides, the ability to replace or reduce the amount of conventional wood preservatives and fungicides by use of the present invention offers additional benefits as well.

By way of a non-limiting example, set forth below are a few representative examples of existing fungicides and mold and mildew control agents, the use of which can be augmented by the inclusion of effective amounts of the NEL. The fungicides include:
sulfur, dithiocarbamates and their derivatives, such as ferric dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethylthiuram disulfides, ammonia complex of zinc N,N′-ethylenebisdithiocarbamate, ammonia complex of zinc N,N′-propylenebisdithiocarbamate, zinc N,N′-propylenebisdithiocarbamate and N,N′-polypropylenebis (thiocarbamyl) disulfide; nitro derivative, such as dinitro(1-methylheptyl)-phenyl crotonate, 2-sec-butyl-4,6-dinitrophenyl 3,3-dimethylacrylate,2-sec-butyl-4,6-dinitrophenyl isopropylcarbonate and diisopropyl 5-nitroisophthalate; heterocyclic substances, such as 2-heptadecylimidazol-2-yl acetate, 2,4-dichloro-6-(o-chloroanilino)-s-triazine, O,O-diethyl phthalimidophosphonothioate, 5-amino-1-[bis-(dimethylamino)-phosphinyl]-3-phenyl-1,2,4-triazole, 2,3-dicyano-1,4-dithioanthraquinone, 2-thio-1,3-dithio[4,5-b]quinoxaline, methyl 1-(butylcarbamyl)-2-benzimidazolecarbamate, 2-methoxycarbonylaminobenzimidazole, 2-(fur-2-yl)-benzimidazole, 2-(thiazol-4-yl)benzimidazole, N-(1,1,2,2-tetrachloroethylthio)-tetrahydrophthalimide, N-trichloromethylthiotetrahydrophthalimide, N-trichloromethylthiophthalimide, N-dichlorofluoromethylthio-N′,N′-dimethyl-N-phenylsulfuric acid diamide, 5-ethoxy-3-trichloromethyl-1,2,3-thiadiazole, 2-thiocyanatomethylthiobenzothiazole, 1,4-dichloro-2,5-dimethoxybenzene, 4-(2-chlorophenylhydrazono)-3-methyl-5-isoxazolone, 2-thiopyridine 1-oxide, 8-hydroxyquinoline and its copper salt, 2,3-dihydro-5-carboxanilido-6-methyl-1,4-oxathiyne, 2,3-dihydro-5-carboxanilido-6-methyl-1,4-oxathiyne 4,4-dioxide, 2-methyl-5,6-dihydro-4H-pyran-3-carboxanilide, 2-methylfuran-3-carboxanilide, 2,5-dimethylfuran-3-carboxanilide, 2,4,5-trimethylfuran-3-carboxanilide, 2,5-dimethyl-N-cyclohexylfuran-3-carboxamide, N-cyclohexyl-N-methoxy-2,5-diethylfuran-3-carboxamide, 2-methylbenzanilide, 2-iodobenzanilide, N-formyl-N-morpholine-2,2,2-trichloroethylacetal, piperazine-1,4-diylbis-(1-(2,2,2-trichloroethyl)-formamide), 1-(3,4-dichloroanilino)-1-formylamino-2,2,2-trichloroethane, 2,6-dimethyl-N-tridecylmorpholine and its salts, 2,6-dimethyl-N-cyclododecylmorpholine and its salts, N[3-(p-tert.-butylphenyl)-2-methylpropyl]-cis-2,6-dimethylmorpholine, N-3-(p-tert.-butylphenyl)-2-methylpropyl]-piperidine, 1-2-(2,4-dichlorophenyl)-4-ethyl-1,3-dioxolan-2-yl-ethyl]-1H-1,2,4-triazole, 1-[2-(2,4-dichlorophenyl)-4-n-propyl-1,3-dioxolan-2-yl-ethyl]-1H-1,2,4-triazole, N-(n-propyl)-N-(2,4,6-trichlorophenoxyethyl)-N]-imidazolylurea, 1-(4-chlorophenoxy)-3,3-dimethyl-1-(1H-1,2,4-triazol-1-yl)-butan-2-one, 1-(4-chlorophenoxy)-3,3-dimethyl-1-(1H-1,2,4-triazol-1-yl)-butan-2-ol, alpha-(2-chlorophenyl)-alpha-(4-chlorophenyl)-5-pyrimidinemethanol, 5-butyl-(2-dimethylamino-4-hydroxy-6-methylpyrimidine, bis-(p-chlorophenyl)-3-pyridinemethanol, 1,2-bis-(3-ethoxycarbonyl-2-thioureido)-benzene, 1,2-bis-(3-methoxycarbonyl-2-thioureido)-benzene, and various fungicides, such as dodecylguanidine acetate, 3-[3-(3,5-dimethyl-2-oxycyclohexyl)-2-hydroxyethyl]-glutaramide, hexachlorobenzene, DL-methyl-N-(2,6-dimethylphehyl)-N-fur-2-yl alanate, methyl DL-N-(2,6-dimethylphenyl)-N-(2]-methoxyacetyl)-alanate, N-(2,6-dimethylphenyl)-N-chloroacetyl-DL-2-aminobutyrolactone, methyl DL-N-(2,6-dimethylphenyl)-N-(phenylacetyl)-alanate, 5-methyl-5-vinyl-3-(3,5-dichlorophenyl)-2,4-dioxo-1,3-oxazolidine, 3-[3,5-dichlorophenyl]-5-methyl-5-methoxymethyl-1,3-oxazolidine-2,4-dione, 3-(3,5-dichlorophenyl)-1-isopropylcarbamylhydantoin, N-(3,5-dichlorophenyl)-1,2-dimethylcyclopropane-1,2-dicarboximide, 2-cyano-[N-(ethylaminocarbonyl)-2-methoximino]-acetamide, 1-[2-(2,4-dichlorophenyl)-pentyl]-1H-1,2,4-triazole, 2,4-difluoro-a-(1H-1,2,4-triazol-1-ylmethyl)-benzhydryl alcohol, N-(3-chloro-2,6-dinitro-4-trifluoromethylphenyl)-5-trifluoromethyl-3-chloro-2-aminopyridine, and 1-((bis-(4-fluorophenyl)-methylsilyl)-methyl)-1H-1,2,4-triazole.

In addition to the fungicides discussed above, it is believed that the NEL is also compatible for use in combination with conventional algacides as well as a variety of growth inhibitory chemicals which are used in the preservation of wood. It is believed that the NEL may be used in combination or via sequential application so as to confer the antifungal and anti-mold properties in addition to the inhibitory effects of the other chemical compositions and treatment protocols.

The efficacy of the NEL for mold and mildew control are not believed limited to the lumber and wood substrates. It is believed that the demonstrated effectiveness of the NEL against mold and fungi growth will offer similar attributes for a variety of other applications. One such application includes the use of the NEL as part of a seed coating composition. Agricultural seeds, including ornamental seeds and grass seeds, are often coated with various substrates designed to prevent the onset of mold or mildew and also to provide for improved water absorptive abilities. It is believed that the NEL product described herein and at similar concentrations may be incorporated into the seed coating to provide resistance to the onset of pathogenic mold and mildews. Alternatively, the NEL product of the present invention could be applied to germinated seedlings and growing plants to reduce the onset and/or spread of molds, mildews, and rust. For instance, golf courses make frequent use of topical fungicides to maintain the greens and fairways in a disease-free state. The benefits of fungal control using the non-toxic NEL product disclosed herein is beneficial in that the exposure to players and hazardous runoff to surrounding waterways can be greatly lessened.

Given the effectiveness of the NEL product with respect to controlling mold and mildew on cellulosic wood products, it is believed that the fungal growth on other organic substrates can also be controlled. For instance, many harvested foods including grains such as corn, legumes including peanuts, and other foods that are stored for extensive periods of time prior to distribution or processing frequently are subject to mold growth during storage. Many of these molds are associated with potentially toxic byproducts such as alfatoxins which are particularly prevalent in peanuts. It is believed that an effective amount of the NEL product can be applied to various harvested foods. Following a drying interval, the stored foods then have enhanced capabilities for preventing and/or reducing the growth of undesired molds and mildews. The non-hazardous nature of the NEL is an added benefit with respect to subsequent processing of the treated foods.

The non-toxic nature of the NEL also makes the extract an ideal candidate for preventing growth of common household mold and mildew on non-porous surfaces such as ceramic tile, porcelain, fiberglass, marble, and similar substrates commonly found in bathrooms and kitchens. These high humidity areas require frequent cleaning and/or treatment to remove and control the growth of mold. The ability to periodically apply an effective amount of the NEL product in an aqueous medium offers an ability to control the growth of such organisms without using potentially hazardous chemicals.

The NEL solution described herein is believed to represent a complex mixture of compounds found within garlic extracts. While it is believed that the most cost effective way of providing a fungal treatment solution is through the use of garlic extracts, it is possible that the more active compounds within the NEL extracts could be combined so as to produce a fungal inhibitory composition. Among the compounds believed most useful with respect to antifungal properties are aliin, allicin, ajoene, vinyldithiines, and diallyl disulfide. Accordingly, combinations of one or more of the above described compounds could be used as a substitute for the NEL products and may provide for similar results. However, the ease and economy of preparation of the NEL solution is the preferred composition for use as an inhibitory agent for mold and mildew.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged, both in whole or in part. Therefore, the spirit and scope of the appended claims should not be limited to the description of the preferred versions contained therein.

1. A method for protecting cellulosic materials from fungi comprising applying to the cellulosic material a solution comprising an effective amount of an extract of Allium sativum.

2. A method as set forth in claim 1 in which the solution is applied to the cellulosic material by spraying.

3. A method as set forth in claim 1 wherein the solution is applied by dipping the cellulosic material into the solution.

4. A method as set forth in claim 1 in which the solution is applied to the cellulosic material by a pressure treatment process.

5. The method according to claim 1 wherein the cellulosic material is selected from the group consisting of green lumber, dried lumber, and pressure treated lumber.

6. The method according to claim 1 wherein said cellulosic products further define cellulosic products selected from the group consisting of green lumber, dried lumber, pressure treated lumber, seeds, grains, legumes, fruits, vegetables, and plants.

7. The method according to claim 1 wherein said cellulosic material is wood and said process further includes applying an additional wood preservative.

8. The method according to claim 1 wherein the effective amount of the extract is about 1:1 volume/volume to about 1:100,000,000 volume/volume.

9. A composition useful in preventing the growth of mold and mildew on non-porous surfaces comprising an effective amount of a garlic extract.

10. A composition according to claim 9 wherein said non-porous surfaces includes the group consisting of porcelain, ceramic, marble, synthetic marble, fiberglass, stainless steel, and plastic.

11. A composition for protecting cellulosic materials from fungi comprising a solution of about 1:1 volume/volume to about 1:100,000,000 volume/volume of an extract of Allium sativum.

12. A processed wood product comprising:
a treated lumber article having at least a surface of said article containing an effective amount of an antifungal agent, said antifungal agent comprising an extract of Allium sativum.

13. The wood product according to claim 12 wherein said extract has been injected by pressure to at least a portion of a subsurface of said article.
